(19) United States
(12) Patent Application Publication
(10) Pub. No.: US 2021/0309776 A1
(43) Pub. Date: Oct. 7, 2021

(54) FLUORINATED POLYMER AND SURFACE TREATING AGENT COMPOSITION

(71) Applicant: DAIKIN INDUSTRIES, LTD., Osaka (JP)

(72) Inventors: Shinichi MINAMI, Shanghai (CN); Masaki Fukumori, Osaka (JP); Takashi Enomoto, Osaka (JP); Takuya Yoshioka, Shanghai (CN); Ikuo Yamamoto, Osaka (JP); Bin Zhou, Shanghai (CN); Min Zhu, Shanghai (CN)

(73) Assignee: DAIKIN INDUSTRIES, LTD., Osaka (JP)

(21) Appl. No.: 17/353,569

(22) Filed: Jun. 21, 2021

Related U.S. Application Data
(62) Division of application No. 16/345,984, filed on Apr. 29, 2019.

(30) Foreign Application Priority Data
Nov. 1, 2016 (CN) 201610933454.3

(51) Int. Cl. C08F 214/18; C08F 220/18; D06M 15/256

(52) U.S. Cl. CPC C08F 214/18; D06M 15/256; C08F 220/18

(57) ABSTRACT

Provided is a fluorinated polymer that can impart excellent washing durability and water- and oil-repellency to fibers, said fluorinated polymer having a repeating unit derived from a fluorinated monomer (a) that comprises a first fluorinated monomer (a1) represented by the formula: CH₂═C(—X¹)—C(═O)—Y¹—Z¹—Rf¹ [wherein X¹ represents a halogen atom; Y¹ represents —O— or —NH—; Z¹ represents a direct bond or a bivalent organic group; and Rf¹ represents a fluoroalkyl group having 1 to 20 carbon atoms] and a second fluorinated monomer (a2) represented by the formula: CH₂═C(—X²)—C(═O)—Y²—Z²—Rf² [wherein X² represents a monovalent organic group or a hydrogen atom; Y² represents —O— or —NH—; Z² represents a direct bond or a bivalent organic group; and Rf² represents a fluoroalkyl group having 1 to 20 carbon atoms].

### CROSS-REFERENCE TO RELATED APPLICATIONS

This application is a Rule 53(b) Divisional of U.S. application Ser. No. 16/345,984 filed Apr. 29, 2019, which is a National Stage of International Application No. PCT/JP2017/039270 filed Oct. 31, 2017, claiming priority based on Chinese Patent Application No. 201610933454.3 filed Nov. 1, 2016, the disclosures of which are incorporated herein by reference in their respective entireties.

### TECHNICAL FIELD

The present invention relates to a fluorine-containing polymer and a surface-treating composition such as a water- and oil-repellent composition comprising the same. Specifically, the present invention relates to an water- and oil-repellent composition which can impart excellent water-repellency, oil-repellency, antifouling property to textile products (for example, carpets), paper, nonwoven fabrics, stone materials, electrostatic filters, dust masks and parts of fuel cell.

### BACKGROUND ART

Conventionally, various fluorine-containing compounds have been proposed. The fluorine-containing compound has an advantage that it is excellent in characteristics such as heat resistance, oxidation resistance and weather resistance. A fluorine-containing compound is used, for example, as a water- and oil-repellent agent and a soil resistant agent by utilizing the property that the free energy of the fluorine-containing compound is low, that is, it is difficult to adhere.

The fluorine-containing compounds which can be used as the water- and oil-repellent agent include a fluorine-containing polymer which comprises (meth)acrylate ester having a fluoroalkyl group as a constituent monomer. Various recent research results indicate that in a practical treatment of fibers with the surface-treating agent, the important surface property is not a static contact angle, but is a dynamic contact angle, particularly a reversing contact angle. That is, the advancing contact angle of water is not dependent on the carbon number of the fluoroalkyl side chain, but the reversing contact angle of water in the case of carbon number of at most 7 is remarkably low than that in the case of carbon number of at least 8. In correspondence to this, an X-ray analysis shows that the side chain crystallizes when the carbon number of side chain is at least 7. It is known that the actual water-repellency has relationship with the crystallization of the side chain and that mobility of the surface-treating agent molecules is an important factor for expression of the actual performances (for example, MAEKAWA Takashige, FINE CHEMICAL, Vol. 23, No. 6, page 12 (1994)). Accordingly, it has been believed that the acrylate polymer having low carbon number of fluoroalkyl group in the side chain which is at most 7 (particularly 6) has low crystallinity so that the polymer cannot satisfy the actual performances (particularly water-repellency). Further, since there are many treatments using auxiliaries such as a softening agent and an antistatic agent in the water- and oil-repellency treatment, there is a problem that practical performance is not satisfied when these agents are used in combination.

JP2013-151651A discloses a fluorine-containing composition comprising a fluorine-containing polymer having repeating units derived from (A) a fluorine-containing monomer which is an α-chloroacrylate having a fluoroalkyl group, (B) a monomer having a linear or branched hydrocarbon group, which has no fluoroalkyl group and (C) a monomer having a cyclic hydrocarbon group, which has no fluoroalkyl group. However, washing durability has not been adequately studied. In addition, JP2010-534740A discloses a plurality of types of fluorine-containing monomers, but combinations of fluorine-containing monomers are not specifically described or studied.

### RELATED ART DOCUMENT

### Patent Documents

[Patent Document 1] JP2013-151651A

[Patent Document 2] JP2010-534740A

### SUMMARY OF THE INVENTION

### Problems to be Solved by the Invention

One object of the present invention is to provide a fluorine-containing polymer and a surface-treating composition which can impart excellent washing durability and water- and oil-repellency to fibers.

### Means to Solve the Problems

The present invention relates to (1) a fluorine-containing polymer having a repeating unit derived from a fluorine-containing monomer comprising (a1) a first fluorine-containing monomer and (a2) a second fluorine-containing monomer.

The present invention provides:

(1) a fluorine-containing polymer having a repeating unit derived from a fluorine-containing monomer (a) comprising a first fluorine-containing monomer (a1) and a second fluorine-containing monomer (a2),
wherein the first fluorine-containing monomer (a1) is a compound represented by the formula:

CH₂═C(—X¹)—C(═O)—Y¹—Z¹—Rf¹

in which, X¹ is a halogen atom,

### Y¹ is —O— or —NH—,

Z¹ is a direct bond or a divalent organic group, and
Rf¹ is a fluoroalkyl group having 1 to 20 carbon atoms, and
the second fluorine-containing monomer (a2) is a compound represented by the formula:

CH₂═C(—X²)—C(═O)—Y²—Z²—Rf²

in which, X² is a monovalent organic group or a hydrogen atom,

### Y² is —O— or —NH—,

Z² is a direct bond or a divalent organic group, and
Rf² is a fluoroalkyl group having 1 to 20 carbon atoms.

### Effect of the Invention

According to the present invention, excellent water-repellency, oil-repellency, antifouling property and soil release property, for example, excellent durability of water- and oil-repellency can be obtained.

The surface-treating composition of the present invention can be used as a water- and oil-repellent composition, a soil resistant composition and/or a soil release composition.

The surface-treating composition of the present invention can impart good water-repellency, oil-repellency, antifouling property and soil releasability to a substrate to be treated even when the heat treatment temperature of the treated substrate is low.

### MODE FOR CARRYING OUT THE INVENTION

The surface-treating composition comprises:

(1) a fluorine-containing polymer,
(2) a liquid medium, and
(3) a surfactant.

The surface-treating composition may further comprise:

(4) a curing agent.

The surface-treating composition may further comprise:

(5) another component.

### (1) Fluorine-Containing Polymer

The fluorine-containing polymer has a repeating unit derived from a monomer comprising a fluorine-containing monomer. The fluorine-containing polymer may consist of the repeating unit derived from the fluorine-containing monomer (a). In addition to the repeating unit derived from the fluorine-containing monomer, the fluorine-containing polymer preferably has a repeating unit derived from the fluorine-free monomer (b).

### (a) Fluorine-Containing Monomer

The fluorine-containing monomer (a) comprises a combination of a first fluorine-containing monomer (a1) having a fluoroalkyl group and an acryloyl group having a halogen group at an α-position and a second fluorine-containing monomer (a2) having a fluoroalkyl group and an acryloyl group having a monovalent organic group or a hydrogen atom at an α-position. The fluorine-containing monomer (a) may comprise fluorine-containing monomers other than the first fluorine-containing monomer (a1) and the second fluorine-containing monomer (a2), but preferably consists of the first fluorine-containing monomer (a1) and the second fluorine-containing monomer (a2).

### (a1) First Fluorine-Containing Monomer

The first fluorine-containing monomer (a1) is preferably a compound represented by the formula:

CH₂═C(—X¹)—C(═O)—Y¹—Z¹—Rf¹

wherein
X¹ is a halogen atom,

### Y¹ is —O— or —NH—,

Z¹ is a direct bond or a divalent organic group,
Rf¹ is a fluoroalkyl group having 1 to 20 carbon atoms.

X¹ is preferably a fluorine atom, a chlorine atom, a bromine atom or an iodine atom. Representative specific examples of X¹ are Cl, Br, I and F, and X¹ is preferably Cl.

Y¹ is preferably —O—.

Examples of Z¹ include a direct bond, an aliphatic group having 1 to 10 carbon atoms, an aromatic group or a cycloaliphatic group having 6 to 18 carbon atoms, a group represented by the formula —R²(R¹)N—SO₂— or —R²(R¹)N—CO— (wherein R¹ is an alkyl group having 1 to 10 carbon atoms and R² is a linear alkylene group or a branched alkylene group having 1 to 10 carbon atoms), a group represented by the formula —CH₂CH(OR³)CH₂—(Ar—O)ₚ— (wherein R³ is a hydrogen atom or an acyl group having 1 to 10 carbon atoms (for example, formyl or acetyl, etc.), Ar is an arylene group optionally having a substituent group and p is 0 or 1), a group represented by the formula —(CH₂)ᵣ—Ar—(O)_{q}— (wherein Ar is an arylene group optionally having a substituent, q is 0 or 1, and r is 0 to 10) or a group represented by the formula —(CH₂)ₘ—SO₂—(CH₂)ₙ— or —(CH₂)ₘ—S—(CH₂)ₙ—(wherein m is 1 to 10 and n is 0 to 10.). The aliphatic group is preferably an alkylene group (particularly having 1 to 4 carbon atoms, such as 1 or 2 carbon atoms). The aromatic group or cycloaliphatic group may be substituted or unsubstituted. The S group or the SO₂ group may be directly bonded to the Rf¹ group.

In the monomer (a1), the Rf¹ group is preferably a perfluoroalkyl group. The carbon number of the Rf¹ group is preferably 1 to 12, for example 1 to 6, especially 4 to 6, more preferably 6. Examples of the Rf¹ group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂ and —C₈F₁₇.

Specific examples of the monomer (a1) include, but are not limited to, the following:

CH₂═C(—Cl)—C(═O)—O—(CH₂)₂—Rf¹

CH₂═C(—F)—C(═O)—O—(CH₂)₂—S—Rf¹

CH₂═C(—F)—C(═O)—O—(CH₂)₂—S—(CH₂)₂—Rf¹

CH₂═C(—F)—C(═O)—O—(CH₂)₂—SO₂—Rf¹

CH₂═C(—F)—C(═O)—O—(CH₂)₂—SO₂—(CH₂)₂—Rf¹

CH₂═C(—F)—C(═O)—NH—(CH₂)₂—Rf¹

CH₂═C(—Cl)—C(═O)—O—(CH₂)₂—S—Rf¹

CH₂═C(—Cl)—C(═O)—O—(CH₂)₂—S—(CH₂)₂—Rf¹

CH₂═C(—Cl)—C(═O)—O—(CH₂)₂—SO₂—Rf¹

CH₂═C(—Cl)—C(═O)—O—(CH₂)₂—SO₂—(CH₂)₂—Rf¹

CH₂═C(—Cl)—C(═O)—NH—(CH₂)₂—Rf¹

CH₂═C(—F)—C(═O)—O—(CH₂)₃—S—Rf¹

CH₂═C(—F)—C(═O)—O—(CH₂)₃—S—(CH₂)₂—Rf¹

CH₂═C(—F)—C(═O)—O—(CH₂)₃—SO₂—Rf¹

CH₂═C(—F)—C(═O)—O—(CH₂)₃—SO₂—(CH₂)₂—Rf¹

CH₂═C(—F)—C(═O)—NH—(CH₂)₃—Rf¹

CH₂═C(—Cl)—C(═O)—O—(CH₂)₃—S—Rf¹

CH₂═C(—Cl)—C(═O)—O—(CH₂)₃—S—(CH₂)₂—Rf¹

CH₂═C(—Cl)—C(═O)—O—(CH₂)₃—SO₂—Rf¹

CH₂═C(—Cl)—C(═O)—O—(CH₂)₃—SO₂—(CH₂)₂—Rf¹

### (a2) Second Fluorine-Containing Monomer

The second fluorine-containing monomer (a2) is preferably a compound represented by the formula:

CH₂═C(—X²)—C(═O)—Y²—Z²—Rf²

wherein
X² is a monovalent organic group or a hydrogen atom,

### Y² is —O— or —NH—,

Z² is a direct bond or a divalent organic group,
Rf² is a fluoroalkyl group having 1 to 20 carbon atoms.

X² is preferably a linear or branched alkyl group having 2 to 21 carbon atoms or a hydrogen atom. Representative examples of X² include a methyl group and a hydrogen atom, and a hydrogen atom is particularly preferred.

Y² is preferably —O—.

Examples of Z² include a direct bond, an aliphatic group having 1 to 10 carbon atoms, an aromatic group or a cycloaliphatic group having 6 to 18 carbon atoms, a group represented by the formula —R²(R¹)N—SO₂— or —R²(R¹)N—CO— (wherein R¹ is an alkyl group having 1 to 10 carbon atoms and R² is a linear alkylene group or a branched alkylene group having 1 to 10 carbon atoms), a group represented by the formula —CH₂CH(OR³)CH₂—(Ar—O)ₚ— (wherein R³ is a hydrogen atom or an acyl group having 1 to 10 carbon atoms (for example, formyl or acetyl, etc.), Ar is an arylene group optionally having a substituent group and p is 0 or 1), a group represented by the formula —(CH₂)ᵣ—Ar—(O)_{q}— (wherein Ar is an arylene group optionally having a substituent, q is 0 or 1, and r is 0 to 10) or a group represented by the formula —(CH₂)ₘ—SO₂—(CH₂)ₙ— or —(CH₂)ₘ—S—(CH₂)ₙ—(wherein m is 1 to 10 and n is 0 to 10.) The aliphatic group is preferably an alkylene group (particularly having 1 to 4 carbon atoms, such as 1 or 2 carbon atoms). The aromatic group or cycloaliphatic group may be substituted or unsubstituted. The S group or the SO₂ group may be directly bonded to the Rf² group.

In the monomer (a2), the Rf² group is preferably a perfluoroalkyl group. The carbon number of the Rf² group is preferably 1 to 12, for example 1 to 6, especially 4 to 6, more preferably 6. Examples of the Rf² group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂ and —C₈F₁₇.

Specific examples of the monomer (a2) include, but are not limited to, the following:

CH₂═C(—H)—C(═O)—O—(CH₂)₂—Rf²

CH₂═C(—H)—C(═O)—O—C₆H₄—Rf²

CH₂═C(—H)—C(═O)—O—(CH₂)₂N(—CH₃) SO₂—Rf²

CH₂═C(—H)—C(═O)—O—(CH₂)₂N(—C₂H₅) SO₂—Rf²

CH₂═C(—H)—C(═O)—O—CH₂CH(—OH) CH₂—Rf²

CH₂═C(—H)—C(═O)—O—CH₂CH(—OCOCH₃) CH₂—Rf²

CH₂═C(—H)—C(═O)—O—(CH₂)₂—S—Rf²

CH₂═C(—H)—C(═O)—O—(CH₂)₂—S—(CH₂)₂—Rf²

CH₂═C(—H)—C(═O)—O—(CH₂)₃—SO₂—Rf²

CH₂═C(—H)—C(═O)—O—(CH₂)₂—SO₂—(CH₂)₂—Rf²

CH₂═C(—H)—C(═O)—NH—(CH₂)₂—Rf²

CH₂═C(—CH₃)—C(═O)—O—(CH₂)₂—Rf²

CH₂═C(—CH₃)—C(═O)—O—C₆H₄—Rf²

CH₂═C(—CH₃)—C(═O)—O—(CH₂)₂N(—CH₃) SO₂—Rf²

CH₂═C(—CH₃)—C(═O)—O—(CH₂)₂N(—C₂H₅) SO₂—Rf²

CH₂═C(—CH₃)—C(═O)—O—CH₂CH(—OH) CH₂—Rf²

CH₂═C(—CH₃)—C(═O)—O—CH₂CH(—OCOCH₃) CH₂—Rf²

CH₂═C(—CH₃)—C(═O)—O—(CH₂)₂—S—Rf²

CH₂═C(—CH₃)—C(═O)—O—(CH₂)₂—S—(CH₂)₂—Rf²

CH₂═C(—CH₃)—C(═O)—O—(CH₂)₃—SO₂—Rf²

CH₂═C(—CH₃)—C(═O)—O—(CH₂)₂—SO₂—(CH₂)₂—Rf²

CH₂═C(—CH₃)—C(═O)—NH—(CH₂)₂—Rf²

### (b) Fluorine-Free Monomer

The fluorine-free monomer (b) is a monomer having no fluorine atom. The fluorine-free monomer (b) is a compound having at least one ethylenically unsaturated double bond. The fluorine-free monomer (b) may be a fluorine-free non-crosslinkable monomer (b1) or a fluorine-free crosslinkable monomer (b2).

### (b1) Fluorine-Free Non-Crosslinkable Monomer

An example of the fluorine-free non-crosslinkable monomer (b1) may be a compound represented by the formula:

CH₂=CA-T

wherein
A is a hydrogen atom, a methyl group or a halogen atom (for example, a chlorine atom, a bromine atom and an iodine atom) other than a fluorine atom,
T is a hydrogen atom, a halogen atom (for example, a chlorine atom, a bromine atom and an iodine atom) other than a fluorine atom, a chain or cyclic hydrocarbon group having 1 to 30 carbon atoms or a chain or cyclic organic group having 1 to 30 carbon atoms and having an ester bond.

Examples of the chain or cyclic hydrocarbon group having 1 to 30 carbon atoms include a linear or branched, saturated or unsaturated (e.g., ethylenically unsaturated) aliphatic hydrocarbon group having 1 to 30 carbon atoms, a saturated or unsaturated (e.g., ethylenically unsaturated) cycloaliphatic group having 4 to 30 carbon atoms, an aromatic hydrocarbon group having 6 to 30 carbon atoms and an araliphatic hydrocarbon group having 7 to 30 carbon atoms.

Examples of the chain or cyclic organic group having 1 to 30 carbon atoms and having an ester bond include —C(═O)—O-Q and —O—C(═O)-Q (wherein Q is a linear or branched, saturated or unsaturated (e.g., ethylenically unsaturated) aliphatic hydrocarbon group having 1 to 20 carbon atoms, a saturated or unsaturated (e.g., ethylenically unsaturated) cycloaliphatic group having 4 to 20 carbon atoms, an aromatic hydrocarbon group having 6 to 20 carbon atoms or an araliphatic hydrocarbon group having 7 to 20 carbon atoms).

The fluorine-free non-crosslinkable monomer (b1) may include an acrylate ester monomer (b1-1) and a halogenated olefin monomer (b1-2).

Examples of the acrylate ester monomer (b1-1) include:

CH₂=CA²¹-C(═O)—O-A²²

wherein
A²¹ is a hydrogen atom, a monovalent organic group or a halogen atom other than a fluorine atom and
A²² is a hydrocarbon group having 1 to 30 carbon atoms.

A²¹ is preferably a hydrogen atom, a methyl group or a chlorine atom.

A²² (hydrocarbon group) may include an acyclic aliphatic hydrocarbon group having 1 to 30 carbon atoms, and a cyclic hydrocarbon-containing group having 4 to 30 carbon atoms. The number of carbon atoms of the acyclic aliphatic hydrocarbon group is preferably 12 to 30, more preferably 18 to 25. Specific examples of the acyclic aliphatic hydrocarbon group are lauryl, cetyl, stearyl and behenyl. Specific examples of the cyclic hydrocarbon group are a cyclohexyl group, a t-butylcyclohexyl group, an isobornyl group, a dicyclopentanyl group, a dicyclopentenyl group, and an adamantyl group.

Specific examples of the acrylate ester monomer having an acyclic aliphatic hydrocarbon group include lauryl (meth)acrylate, cetyl (meth)acrylate, stearyl (meth)acrylate, behenyl (meth)acrylate.

Specific examples of the acrylate ester monomer having a cyclic hydrocarbon-containing group include cyclohexyl (meth)acrylate, t-butylcyclohexyl (meth)acrylate, benzyl (meth)acrylate, isobornyl (meth)acrylate, dicyclopentanyl (meth)acrylate, dicyclopentenyl (meth)acrylate, dicyclopentanyloxyethyl (meth)acrylate, tricyclopentanyl (meth)acrylate, adamantyl (meth)acrylate, 2-methyl-2-adamantyl (meth)acrylate and 2-ethyl-2-adamantyl (meth)acrylate.

The halogenated olefin monomer (b1-2) has no fluorine atom.

The halogenated olefin monomer may be an olefin having 2 to 20 carbon atoms substituted with 1 to 10 chlorine, bromine or iodine atoms. The halogenated olefin monomer is preferably a chlorinated olefin having 2 to 20 carbon atoms, particularly an olefin having 2 to 5 carbon atoms and having 1 to 5 chlorine atoms. Preferred specific examples of the halogenated olefin monomer (b1-2) are vinyl halides such as vinyl chloride, vinyl bromide and vinyl iodide, and vinylidene halides such as vinylidene chloride, vinylidene bromide, vinylidene iodide. Since water- and oil-repellency (especially durability of water- and oil-repellency) becomes high, vinyl chloride and vinylidene chloride are preferred, and vinyl chloride is particularly preferred.

### (b2) Fluorine-Free Crosslinkable Monomer

The fluorine-free crosslinkable monomer (b2) is a monomer comprising no fluorine atom. The fluorine-free crosslinkable monomer may be a fluorine-free compound having at least two reactive groups and/or olefinic carbon-carbon double bond (preferably (meth)acrylate group). The fluorine-free crosslinkable monomer is a compound having at least two olefinic carbon-carbon double bonds (preferably (meth)acrylate groups), or at least one olefinic carbon-carbon double bond and at least one reactive group. Examples of the reactive group include a hydroxyl group, an epoxy group, a chloromethyl group, a blocked isocyanate group, an amino group, and a carboxyl group.

The fluorine-free crosslinkable monomer may be a mono(meth)acrylate, di(meth)acrylate, mono(meth)acrylamide or di(meth)acrylamide having a reactive group. Alternatively, the fluorine-free crosslinkable monomer may be di(meth)acrylate or di(meth)acrylamide.

Preferred fluorine-free crosslinkable monomer is a compound represented by the formula:

CH₂=CE¹-C(═O)-E²-E³-E⁴

wherein
E¹ is a hydrogen atom, a methyl group or a halogen atom (for example, a chlorine atom, a bromine atom and an iodine atom) other than a fluorine atom,

### E² is —O— or —NH—,

E³ is an organic group having 1 to 20 carbon atoms, for example, a linear or branched aliphatic group having 1 to 20 carbon atoms (particularly, an alkylene group), for example, a group represented by the formula —(CH₂)ₓ—(wherein x is 1 to 10),
E⁴ is a hydroxyl group, an epoxy group, a chloromethyl group, a blocked isocyanate group, an amino group, or a carboxyl group.].

Examples of monomer (b2) having a hydroxyl group include N-methylol (meth)acrylamide, N-2-propylol (meth)acrylamide, N-butyrol (meth)acrylamide and hydroxyethyl (meth)acrylate.

Other examples of the fluorine-free crosslinkable monomer (b2) include (meth)acrylic acid, diacetone(meth)acrylamide, (meth)acrylamide, 3-chloro-2-hydroxypropyl (meth)acrylate, 2-acetoacetoxyethyl (meth)acrylate, butadiene, isoprene, chloroprene, glycidyl (meth)acrylate, 1,6-hexanediol di(meth)acrylate and neopentyl glycol di(meth)acrylate.

### (b3) Other Fluorine-Free Monomer

The fluorine-containing polymer may comprise a fluorine-free monomer (b3) other than the monomers (b1) and (b2).

Examples of the other fluorine-free monomer (b3) include ethylene, vinyl acetate, acrylonitrile, styrene, polyethylene glycol (meth)acrylate, polypropylene glycol (meth)acrylate, methoxypolyethylene glycol (meth)acrylate, methoxypolypropylene glycol (meth)acrylate and vinyl alkyl ether. Other fluorine-free monomers are not limited to these examples.

The monomer (b) may be used alone or in combination of two or more. Each of the monomers (a1), (a2), (b1), (b1-1), (b1-2), (b2) and (b3) may be used alone or in combination of two or more.

In the fluorine-containing polymer, the amount of the fluorine-containing monomer (a) (generally, the total amount of the first fluorine-containing monomer (a1) and the second fluorine-containing monomer (a2)) is at least 10% by weight, for example, at least 40% by weight. The amount of the fluorine-containing monomer (a) may be at most 95% by weight, for example, at most 80% by weight, or at most 75% by weight or at most 70% by weight, based on the fluorine-containing polymer.

In the fluorine-containing polymer, the weight ratio (a1):(a2) of the first fluorine-containing monomer (a1) to the second fluorine-containing monomer (a2) may be 5:95 to 95:5, for example 10:90 to 90:10, especially 15:85 to 85:15, particularly 20:80 to 80:20.

For example, the weight ratio (a1):(a2) of the first fluorine-containing monomer (a1) to the second fluorine-containing monomer (a2) may be 5:95 to 75:25, preferably 10:90 to 50:50, more preferably from 15:85 to 45:55, further preferably from 20:80 to 45:55, especially 20:80 to 40:60. These weight ratios are particularly preferred when the fluorine-containing polymer is applied to a nonwoven fabric.

Alternatively, the weight ratio (a1):(a2) of the first fluorine-containing monomer (a1) to the second fluorine-containing monomer (a2) may be 25:75 to 95:5, preferably 35:65 to 85:15, more preferably 45:55 to 80:20, further preferably 50:50 to 75:25. These weight ratios are particularly preferred when the fluorine-containing polymer is applied to a knitted/woven material (a knitted material or a woven material), particularly a knitted/woven fabric (a knitted fabric or a woven fabric).

In the fluorine-containing polymer, based on 100 parts by weight of the fluorine-containing monomer (a),

the amount of the fluorine-free monomer (b) may be 1 to 300 parts by weight, preferably 10 to 200 parts by weight.

In the fluorine-containing polymer, based on 100 parts by weight of the fluorine-containing monomer (a),

the amount of the fluorine-free non-crosslinkable monomer (b1) may be 1 to 200 parts by weight, preferably 10 to 100 parts by weight,
the amount of the fluorine-free crosslinkable monomer (b2) may be 0 to 100 parts by weight, for example 1 to 30 parts by weight,
the amount of the other fluorine-free monomer (b3) may be 0 to 100 parts by weight, for example 1 to 30 parts by weight.

In the fluorine-containing polymer, based on 100 parts by weight of the fluorine-containing monomer (a),

the amount of the monomer (b1-1) may be 0 to 150 parts by weight, preferably 1 to 70 parts by weight,
the amount of the halogenated olefin monomer (b1-2) may be 0 to 150 parts by weight, preferably 1 to 60 parts by weight, and other fluorine-free monomer may be used.

Alternatively, based on the total amount of the fluorine-containing monomer (a) and the fluorine-free monomer (b) (generally, based on the fluorine-containing polymer), the amount of the fluorine-containing monomer (a) may be 20 to 90% by weight, preferably 30 to 80% by weight, more preferably 35 to 70% by weight, especially 40 to 65% by weight,

the amount of the fluorine-free monomer (b) may be 10 to 80% by weight, preferably 20 to 70% by weight, more preferably 30 to 65% by weight, especially 35 to 60% by weight.

Based on the fluorine-containing polymer, the amount of the fluorine-free non-crosslinkable monomer (b1) may be 20 to 70% by weight, preferably 25 to 60% by weight, particularly preferably 30 to 55% by weight,

the amount of the fluorine-free crosslinkable monomer (b2) may be 0 to 30 parts by weight, for example 1 to 10 parts by weight,

the amount of the other fluorine-free monomer (b3) may be 0 to 30 parts by weight, for example 1 to 10 parts by weight.

Based on the fluorine-containing polymer, the amount of the acrylate ester monomer (b1-1) may be 20 to 70% by weight, preferably 25 to 60% by weight, especially 30 to 55% by weight, and the amount of the halogenated olefin monomer (b1-2) may be 0 to 60% by weight, for example 5 to 50% by weight, particularly 10 to 40% by weight.

Based on the fluorine-containing treating agent or the surface-treating composition, the amount of the fluorine-containing polymer (solid content) may be about 0.01 to 60% by weight, preferably about 0.1 to 40% by weight, more preferably about 5 to 35% by weight.

The fluorine-containing polymer may be present in the form of a solution dissolved in an organic solvent, but it is preferably present in the form of an aqueous dispersion.

In the present specification, unless explicitly indicated, when simply referred to as “acrylate” or “acrylamide”, a compound in which the α-position is not only a hydrogen atom but also another group (for example, a monovalent organic group including a methyl group or a halogen atom) are included. In the present specification, the term “(meth)acrylate” means an acrylate or methacrylate, and the term “(meth)acrylamide” means an acrylamide or methacrylamide.

### (2) Liquid Medium

The liquid medium may be an aqueous medium. The liquid medium may be water alone or a mixture of water and a (water-miscible)organic solvent. The amount of the organic solvent may be at most 30% by weight, for example, at most 10% by weight (preferably at least 0.1%) based on the liquid medium. The liquid medium is preferably water alone. The liquid medium may be an organic solvent alone. The amount of the liquid medium may be 30 to 99.5% by weight, particularly 50 to 99% by weight, based on the fluorine-containing treating agent (or the surface-treating composition).

The aqueous medium may be added after producing the fluorine-containing polymer by polymerization. For example, after polymerizing a monomer in the presence of an organic solvent to prepare a fluorine-containing polymer, water is added and the organic solvent is distilled off. The organic solvent may not be distilled off. The surfactant may be added before polymerization or after polymerization, or may not be added. Even when the surfactant is not added, an aqueous dispersion in which the fluorine-containing polymer is well dispersed in the aqueous medium can be obtained.

### (3) Surfactant

The surface-treating composition may comprise a surfactant when it is an aqueous dispersion. The surfactant comprises at least one of a nonionic surfactant, a cationic surfactant and an anionic surfactant. In addition, the surfactant may comprise an amphoteric surfactant. Also, it may not comprise a surfactant.

When the surface-treating composition is an aqueous dispersion, it generally comprises a surfactant. When the surface-treating composition is an aqueous solution, the surface-treating composition generally does not comprise a surfactant.

The nonionic surfactant is a nonionic surfactant having an oxyalkylene group. Preferably, the number of carbon atoms of the alkylene group in an oxyalkylene group is from 2 to 10. Preferably, the number of the oxyalkylene groups in the molecule of a nonionic surfactant is from 2 to 100.

The nonionic surfactant may be, for example, an alkylene oxide adduct of linear or branched aliphatic (saturated and/or unsaturated) group, a polyalkylene glycol ester of a linear or branched (saturated and/or unsaturated) fatty acid, a polyoxyethylene (POE)/polyoxypropylene (POP) copolymer (a random copolymer or a block copolymer), an alkylene oxide adduct of acetylene glycol. Among them, preferred is a surfactant wherein structure of an alkylene oxide addition portion and a polyalkylene glycol portion is polyoxyethylene (POE), polyoxypropylene (POP) or a POE/POP copolymer (which may be a random copolymer or may be a block copolymer).

Preferably, the nonionic surfactant has the structure free from an aromatic group from a viewpoint of environmental problems (for example, biodegradability and environmental hormones).

The cationic surfactant may be an amine salt, a quaternary ammonium salt, or an oxyethylene-added ammonium salt. Specific examples of the cationic surfactant include, but are not particularly limited to, amine salt type surfactants such as alkylamine salts, aminoalcohol fatty acid derivatives, polyamine fatty acid derivatives and imidazoline; quaternary ammonium salt type surfactants such as alkyltrimethylammonium salts, dialkyldimethylammonium salts, alkyldimethylbenzylammonium salt, pyridinium salt, alkylisoquinolinium salt and benzethonium chloride

Specific examples of the cationic surfactant include dodecyl trimethyl ammonium acetate, trimethyl tetradecyl ammonium chloride, hexadecyl trimethyl ammonium bromide, trimethyl octadecyl ammonium chloride, (dodecylmethyl benzyl) trimethyl ammonium chloride, benzyl dodecyl dimethyl ammonium chloride, methyldodecyldi(hydropolyoxyethylene)ammonium chloride, benzyldodecyldi(hydro polyoxyethylene)ammonium chloride and N-[2-(diethylamino)ethyl]oleamide hydrochloride.

Examples of the anionic surfactant include a fatty acid salt (the number of carbon atoms of the fatty acid is, for example, 8 to 30), a sulfonate (for example, alkylsulfonic acid, alkylbenzenesulfonate (the number of carbon atoms of the alkyl group is, for example, 8 to 30), a sulfate salt (for example, an alkyl sulfate salt (the number of carbon atoms of the alkyl group is, for example, 8 to 30).

Examples of anionic surfactants are sodium lauryl sulfate, triethanolamine lauryl sulfate, sodium polyoxyethylene lauryl ether sulfate, sodium polyoxyethylene nonylphenyl ether sulfate, polyoxyethylene lauryl ether sulfate triethanolamine, sodium cocoyl sarcosinate, sodium N-cocoyl methyl taurine, sodium polyoxyethylene coco alkyl ether sulfate, sodium diether hexyl sulfosuccinate, sodium α-olefin sulfonate, sodium lauryl phosphate, and sodium polyoxyethylene lauryl ether phosphate.

Examples of the amphoteric surfactant include alanines, imidazolinium betaines, amidobetaines and betaine acetate. Specific examples thereof include lauryl betaine, stearyl betaine, lauryl carboxymethyl hydroxyethyl imidazolinium betaine, lauryl dimethyl aminoacetic betaine, and fatty acid amidopropyldimethylaminoacetic betaine.

Each of nonionic surfactant, cationic surfactant, anionic surfactant, and amphoteric surfactant may be used alone or in combination of two or more.

The surfactant is preferably an anionic surfactant and/or a nonionic surfactant. A combination of an anionic surfactant and a nonionic surfactant is preferred.

In the present invention, even when no surfactant is used, it is possible to form dispersion, particularly aqueous dispersion of the fluorine-containing polymer.

The amount of the surfactant may be from 0.1 to 50 parts by weight, for example, 1 to 30 parts by weight, based on 100 parts by weight of the fluorine-containing polymer (or the total of the monomers).

### [Method for Producing Fluorine-Containing Polymer]

The fluorine-containing polymer in the present invention may be produced by any ordinary polymerization methods, and the conditions of the polymerization reaction can be arbitrarily selected. Examples of such polymerization methods include solution polymerization, suspension polymerization, and emulsion polymerization.

In the solution polymerization, a method dissolving the monomers in an organic solvent in the presence of a polymerization initiator, conducting nitrogen substitution, and then heating and stirring in the range of 30 to 120° C. for 30 minutes to 48 hours, for example, 3 to 24 hours is adopted. Examples of the polymerization initiator include azobisisobutyronitrile, benzoyl peroxide, di-t-butyl peroxide, lauryl peroxide, cumene hydroperoxide, t-butyl peroxypivalate and diisopropyl peroxydicarbonate. The polymerization initiator may be used in an amount of 0.01 to 20 parts by weight, for example, 0.01 to 10 parts by weight based on 100 parts by weight of the monomer.

The organic solvent is inert to the monomer and dissolves them. Examples thereof include esters (for example, esters having 2 to 30 carbon atoms, specifically, ethyl acetate and butyl acetate), ketones (for example, ketone having a number of 2 to 30 carbons, specifically, methylethyl ketone, diisobutyl ketone), an alcohol (for example, an alcohol having 1 to 30 carbon atoms, specifically and isopropyl alcohol). Specific examples of the organic solvent include acetone, chloroform, HCHC 225, isopropyl alcohol, pentane, hexane, heptane, octane, cyclohexane, benzene, toluene, xylene, petroleum ether, tetrahydrofuran, 1,4-dioxane, methyl ethyl ketone, methyl isobutyl ketone, diisobutyl ketone, ethyl acetate, butyl acetate, 1,1,2,2-tetrachloroethane, 1,1,1-trichloroethane, trichlorethylene, perchlorethylene, tetrachlorodifluoroethane and trichlorotrifluoroethane. The organic solvent may be used in an amount of 10 to 2000 parts by weight, for example, 50 to 1000 parts by weight, based on 100 parts by weight of the total of the monomers.

In the emulsion polymerization, preferably the monomers are emulsified in water in the presence of a polymerization initiator and an emulsifier, then purged with nitrogen, and stirred in the range of 50 to 80° C. for 30 minutes to 48 hours, for example 3 to 24 hours to be polymerized. As the polymerization initiator, water-soluble ones such as benzoyl peroxide, lauroyl peroxide, t-butyl perbenzoate, 1-hydroxycyclohexyl hydroperoxide, 3-carboxypropionyl peroxide, acetyl peroxide, azobisisobutylamidine-dihydrochloride, azobisisobutyronitrile, sodium peroxide, potassium persulfate and ammonium persulfate; oil-soluble ones such as azobisisobutyronitrile, benzoyl peroxide, di-t-butyl peroxide, lauryl peroxide, cumene hydroperoxide, t-butyl peroxypivalate and diisopropyl peroxydicarbonate may be used. The polymerization initiator may be used in the range of 0.01 to 10 parts by weight based on 100 parts by weight of the monomer.

In order to obtain a polymer aqueous dispersion having excellent storage stability, it is desirable that to form fine particles of a monomer in water and polymerized it with an emulsifying device capable of imparting strong crushing energy such as a high pressure homogenizer or an ultrasonic homogenizer. As the emulsifier, anionic, cationic or nonionic emulsifiers can be used, and the emulsifier is used in an amount of 0.5 to 20 parts by weight based on 100 parts by weight of the monomer. It is preferred to use anionic and/or nonionic and/or cationic emulsifiers. When the monomers are incompatible with each other, it is preferred to add a compatibilizer such as a water-soluble organic solvent or a low molecular weight monomer so as to sufficiently compatibilize these monomers. Emulsifiability and copolymerizability can be improved by adding the compatibilizing agent.

Examples of the water-soluble organic solvent include acetone, methylethyl ketone, ethyl acetate, propylene glycol, dipropylene glycol monomethyl ether, dipropylene glycol, tripropylene glycol and ethanol. They are used in the range of 1 to 50 parts by weight, for example 10 to 40 parts by weight, based on 100 parts by weight. Examples of the low molecular weight monomer include methyl methacrylate, glycidyl methacrylate, 2,2,2-trifluoroethyl methacrylate. They are used in the range of 1 to 50 parts by weight, for example, 10 to 40 parts by weight based on 100 parts by weight of the total amount of monomers.

In the polymerization, a chain transfer agent may be used. Depending on the amount of chain transfer agent used, the molecular weight of the polymer can be changed. Examples of the chain transfer agent include mercaptan group-containing compounds (particularly, alkyl mercaptans (having, for example, 1 to 30 carbon atoms)) such as lauryl mercaptan, thioglycol, and thioglycerol; and inorganic salts such as sodium hypophosphite and sodium bisulfite. The amount of the chain transfer agent may be used in the range of 0.01 to 10 parts by weight, for example 0.1 to 5 parts by weight, based on 100 parts by weight of the total amount of the monomers.

It is preferred to produce the fluorine-containing polymer by an emulsion polymerization method or a solution polymerization method.

After producing the fluorine-containing polymer by polymerization, it is preferred to add water (or aqueous medium) to disperse the fluorine-containing polymer in water.

Water (or an aqueous medium) may be added after producing the fluorine-containing polymer by polymerization. For example, after polymerizing a monomer in the presence of an organic solvent to prepare a fluorine-containing polymer, water is added to the polymer mixture, the organic solvent is distilled off, and the fluorine-containing polymer is dispersed in water. The organic solvent may not be distilled off. The surfactant may be added before polymerization or after polymerization, or may not be added. Even when no surfactant is added, a good aqueous dispersion can be obtained.

The surface-treating composition may contain (4) a curing agent (active hydrogen reactive compound or active hydrogen-containing compound). Generally, after the fluorine-containing polymer is produced, the curing agent (4) is added.

### (4) Curing Agent

The surface-treating composition may comprise a curing agent (crosslinking agent) so as to satisfactorily cure the fluorine-containing polymer. Since the fluorine-free crosslinkable (meth)acrylate or (meth)acrylamide monomer is an active hydrogen-containing monomer or an active hydrogen reactive group-containing monomer, the fluorine-containing polymer has an active hydrogen or an active hydrogen reactive group. The curing agent is an active hydrogen reactive compound or an active hydrogen-containing compound so as to react with the active hydrogen or active hydrogen reactive group of the fluorine-containing polymer.

Examples of the active hydrogen reactive compound are polyisocyanate compounds, epoxy compounds, chloromethyl group-containing compounds, carboxyl group-containing compounds and hydrazide compounds.

Examples of the active hydrogen-containing compound are hydroxyl group-containing compounds, amino group-containing compounds, carboxyl group-containing compounds, ketone group-containing compounds, hydrazide compounds and melamine compounds.

The amount of the curing agent may be at most 100 parts by weight, for example, 0.01 to 30 parts by weight based on 100 parts by weight of the fluorine-containing polymer.

The curing agent is preferably a polyisocyanate compound.

The polyisocyanate compound is a compound having two or more isocyanate groups in one molecule. The polyisocyanate compound acts as a crosslinking agent. Examples of the polyisocyanate compound include aliphatic polyisocyanates, alicyclic polyisocyanates, araliphatic polyisocyanates, aromatic polyisocyanates and derivatives of these polyisocyanates.

Examples of the aliphatic polyisocyanates are aliphatic diisocyanate such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate and 2,6-diisocyanatomethylcaproate; and aliphatic triisocyanates such as lysine ester triisocyanate, 1,4,8-triisocyanato octane, 1,6,11-triisocyanatoundecane, 1,8-diisocyanato-4-isocyanatomethyloctane, 1,3,6-triisocyanatohexane, 2,5,7-trimethyl-1,8-diisocyanato-5-isocyanatomethyl octane.

Examples of the alicyclic polyisocyanates are alicyclic diisocyanates and alicyclic triisocyanates. Specific examples of the alicyclic polyisocyanate are 1,3-cyclopentene diisocyanate, 3-isocyanatomethyl-3,5,5-trimethylcyclohexyl isocyanate (isophorone diisocyanate) and 1,3,5-triisocyanatocyclohexane.

Examples of the araliphatic polyisocyanates are araliphatic diisocyanates and araliphatic triisocyanates. Specific examples of the araliphatic polyisocyanates include 1,3- or 1,4-xylylene diisocyanate or mixture thereof, 1,3- or 1,4-bis (1-isocyanato-1-methylethyl)benzene(tetramethylxylylenediisocyanate) or a mixture thereof and 1,3,5-triisocyanatomethylbenzene.

Examples of the aromatic polyisocyanates include aromatic diisocyanates, aromatic triisocyanates and aromatic tetraisocyanates. Specific examples of the aromatic polyisocyanates include m-phenylene diisocyanate, p-phenylene diisocyanate, 4,4′-diphenyl diisocyanate, 1,5-naphthalene diisocyanate, 2,4′- or 4,4′-diphenylmethane diisocyanate or mixtures thereof, 2,4- or 2,6-tolylene diisocyanate or a mixture thereof, triphenylmethane-4,4′,4″-triisocyanate, and 4,4′-diphenylmethane-2,2′,5,5′-tetraisocyanate.

Examples of the derivative of polyisocyanate include various derivatives such as dimer, trimer, biuret, allophanate, carbodiimide, uretdione, uretimine, isocyanurate and iminooxadiazinedione of the above-mentioned polyisocyanate compound.

These polyisocyanates can be used alone or in combination of two or more.

As the polyisocyanate compound, it is preferred to use a blocked polyisocyanate compound (a blocked isocyanate) which is a compound obtained by blocking the isocyanate group of the polyisocyanate compound with a blocking agent. It is preferred to use a blocked polyisocyanate compound because it is relatively stable even in an aqueous solution and can be used in the same aqueous solution as the surface-treating agent.

The blocking agent is an agent which blocks free isocyanate groups. By heating the blocked polyisocyanate compound to, for example, at least 100° C., for example, at least 130° C., the isocyanate group is regenerated and can easily react with the hydroxyl group. Examples of the blocking agent include a phenol compound, a lactam compound, an aliphatic alcohol compound and an oxime compound.

These polyisocyanate compounds can be used alone or in combination of two or more.

The epoxy compound is a compound having an epoxy group. Examples of the epoxy compounds are epoxy compounds having polyoxyalkylene groups, such as polyglycerol polyglycidyl ether and polypropylene glycol diglycidyl ether; and sorbitol polyglycidyl ether and the like.

The chloromethyl group-containing compound is a compound having a chloromethyl group. Examples of the chloromethyl group-containing compounds include chloromethyl polystyrene and the like.

The carboxyl group-containing compound is a compound having a carboxyl group. Examples of the carboxyl group-containing compounds include (poly)acrylic acid and (poly) methacrylic acid.

The ketone group-containing compound is a compound having a ketone group. Examples of the ketone group-containing compounds include (poly)diacetone acrylamide and diacetone alcohol.

The hydrazide compound is a compound having a hydrazide group. Examples of the hydrazide compounds include hydrazine, carbohydrazide and adipic acid hydrazide.

Examples of the melamine compounds include melamine resins and methyl etherified melamine resins.

### (5) Other Component

The surface-treating composition may comprise the component (5) other than the above components (1) to (4). Generally, after the fluorine-containing polymer is produced, the other component (5) is added. Examples of the other components include fluorine-free water-repellent compounds.

### Fluorine-Free Water-Repellent Compound

The surface-treating composition may comprise a fluorine atom-free water repellent compound (fluorine-free water repellent compound).

The fluorine-free water repellent compound may be a fluorine-free acrylate polymer, a saturated or unsaturated hydrocarbon compound or a silicone compound.

The fluorine-free acrylate polymer is a homopolymer consisting of one fluorine-free acrylate monomer, a copolymer comprising at least two fluorine-free acrylate monomers, or a copolymer comprising at least one fluorine-free acrylate monomer and at least one other fluorine-free monomer (such as an ethylenically unsaturated compound, for example, ethylene, vinyl type monomer).

The fluorine-free acrylate monomer composing the fluorine-free acrylate polymer is the compound represented by the formula:

CH₂=CA-T

wherein
A is a hydrogen atom, a methyl group or a halogen atom (for example, a chlorine atom, a bromine atom and an iodine atom) other than a fluorine atom,
T is a hydrogen atom, a chain or cyclic hydrocarbon group having 1 to 30 carbon atoms or a chain or cyclic organic group having 1 to 31 carbon atoms having an ester bond.

Examples of the chain or cyclic hydrocarbon group having 1 to 30 carbon atoms include a linear or branched aliphatic hydrocarbon group having 1 to 30 carbon atoms, a cycloaliphatic group having 4 to 30 carbon atoms, an aromatic hydrocarbon group having 6 to 30 carbon atoms and an aromatic aliphatic hydrocarbon group having 7 to 30 carbon atoms.

Examples of the chain or cyclic organic group having 1 to 31 carbon atoms having an ester bond include —C(═O)—O-Q and —OC(═O)-Q (wherein Q is a linear or branched aliphatic hydrocarbon group having 1 to 30 carbon atoms, a cycloaliphatic group having 4 to 30 carbon atoms, an aromatic hydrocarbon group having 6 to 30 carbon atoms or an araliphatic hydrocarbon group having 7 to 30 carbon atoms).

Examples of the fluorine-free acrylate monomers include alkyl(meth)acrylate, polyethyleneglycol(meth)acrylate, polypropyleneglycol (meth)acrylate, methoxypolyethyleneglycol (meth)acrylate, methoxypolypropyleneglycol (meth)acrylate.

The fluorine-free acrylate monomer is preferably an alkyl(meth)acrylate ester. The number of carbon atoms of the alkyl group may be from 1 to 30, for example from 6 to 30 (for example, from 10 to 30). Specific examples of fluorine-free acrylate monomers include lauryl(meth)acrylate, stearyl(meth)acrylate and behenyl(meth)acrylate.

The fluorine-free acrylate polymer can be produced by the same polymerization method as that of the fluorine-containing polymer.

The saturated or unsaturated hydrocarbon compound is preferably a saturated hydrocarbon. In the saturated or unsaturated hydrocarbon compound, the carbon number may be at least 15, preferably 20 to 300, for example, 25 to 100. Specific examples of the saturated or unsaturated hydrocarbon compound include paraffin.

The silicone compound is generally used as a water repellent agent. The silicone compound is not limited as long as it is a compound showing water-repellency.

The amount of the fluorine-free water repellent compound may be at most 500 parts by weight, for example, 5 to 200 parts by weight, particularly 5 to 100 parts by weight based on 100 parts by weight of the fluorine-containing polymer.

The treating composition of the present invention may be in the form of a solution, an emulsion (particularly an aqueous dispersion) or an aerosol, preferably an aqueous dispersion. The treating composition comprises a polymer (the active component of the surface-treating agent) and a medium (in particular, a liquid medium such as an organic solvent and/or water). The amount of the medium may be, for example, 5 to 99.9% by weight, particularly 10 to 80% by weight, based on the treating composition.

In the treating composition, the concentration of the polymer may be from 0.01 to 95% by weight, for example, 5 to 50% by weight.

The treating composition of the present invention can be applied to a substrate to be treated by a known method. Usually, the fluorine-containing composition is diluted or dispersed with an organic solvent or water, is adhered to surfaces of the substrate by a well-known procedure such as an immersion coating, a spray coating and a foam coating, and is dried. If necessary, it is applied together with a suitable crosslinking agent, followed by curing. It is also possible to add mothproofing agents, softening agents, antibacterial agents, flame retarders, antistatic agents, coating material fixing agents, crease-proofing agents, etc. to the treating composition of the present invention. For the immersion coating, the concentration of the fluorine-containing polymer in the treating liquid contacted with the textile product may be from 0.01 to 10% by weight, for example, 0.05 to 10% by weight, based on the treating liquid.

Examples of the substrate to be treated with the treating composition (for example, a water- and oil-repellent agent) of the present invention include a textile, masonry, a filter (for example, an electrostatic filter), a dust protective mask, a part of fuel cell (for example, a gaseous diffusion electrode and a gaseous diffusion support), glass, paper, wood, leather, fur, asbestos, brick, cement, metal and oxide, ceramics, plastics, a coated surface and a plaster. The textile includes various examples. Examples of the textile include animal- or vegetable-origin natural fibers such as cotton, hemp, wool and silk; synthetic fibers such as polyamide, polyester, polyvinyl alcohol, polyacrylonitrile, polyvinyl chloride and polypropylene; semi-synthetic fibers such as rayon and acetate; inorganic fibers such as glass fiber, carbon fiber and asbestos fiber; and a mixture of these fibers.

The textile may be in the form of a fiber or a fabric.

The treating composition of the present invention can also be used as an internal mold releasing agent or an external mold release agent.

The polymer can be applied to the textile product by any of the methods known for treating textiles (e.g. fabric) with liquids. The textile product may be immersed in the solution or the solution may be deposited or sprayed on the textile product. The treated textile product is preferably dried and cured by heating in order to develop water-repellency and oil-repellency. The heating temperature may be, for example, 100° C. to 200° C., 100° C. to 170° C., or 100° C. to 120° C. Good performance can be obtained even at low temperature heating (for example, 100° C. to 140° C.) in the present invention. In the present invention, the heating time may be 5 seconds to 60 minutes, for example 30 seconds to 3 minutes.

Alternatively, the polymer may be applied to the textile by a cleaning process, for example, may be applied to textile products in laundry applications or dry cleaning processes.

The textile product to be treated is typically fabrics, which includes knitted material (knitted fabrics), woven material (woven fabrics) and nonwoven fabrics and fabrics in the form of clothing and carpets as well as yarns and an intermediate textile product (such as sliver or roving). The treating agent of the present invention is particularly effective in rendering synthetic fibers hydrophobic and water-repellent. Also, the process of the present invention generally renders the textile product hydrophobic and water repellent.

Examples of the fibers composing the textile products are natural fibers, synthetic fibers, semisynthetic fibers, regenerated fibers and inorganic fibers. One kind of fiber may be used alone, or two or more kinds may be used in combination.

Examples of the natural fibers are cellulosic fibers such as cotton, flax, wood pulp, chitin, chitosan, wool and silk. Specific examples of wood pulp include mechanical pulp such as ground wood pulp (GP), pressurized ground wood pulp (PGW) and thermomechanical pulp (TMP); chemical pulp such as high yield softwood unbleached kraft pulp (HNKP; N material), softwood bleached kraft pulp (NBKP; N material, NB material), hardwood unbleached kraft pulp (LUKP; L material), hardwood bleached kraft pulp (LBKP, L material); used paper pulp such as deinking pulp (DIP) and waste pulp (WP); and semi-chemical pulp (CP).

Examples of the synthetic fibers include polyesters such as polyethylene terephthalate, polybutylene terephthalate, polytrimethylene terephthalate, copolyester; polyolefins such as linear low density polyethylene, low density polyethylene, high density polyethylene and polypropylene; polyamide such nylon 6, nylon 66, nylon 610, and nylon 46; acrylic fiber such as polyacrylonitrile; polyvinyl alcohol, polyurethane and polyvinyl chloride.

Examples of the semisynthetic fibers include acetate and triacetate.

Examples of the regenerated fibers are rayon, cupra, polynocic rayon, lyocell and tencel.

Examples of the inorganic fibers include glass fiber and carbon fiber.

Alternatively, the fibrous substrate can be a leather. The polymeric product can be applied to leather from aqueous solution or emulsion at various stages of leather processing, for example during leather wet end processing or during leather finishing, to render the leather hydrophobic and oleophobic. The fibrous substrate can alternatively be paper. The polymeric product can be applied to preformed paper or at various stages of papermaking, for example during drying of the paper.

The term “treatment” means that the treating agent is applied to the substrate by, for example, immersion, spray, or coating. The fluorine-containing polymer which is an active component of the treating agent can penetrate the internal of the substrate or can adhere on the surface of the substrate by the treatment.

The present invention is now described in detail by way of Examples. However, the present invention is not limited to these Examples.

In the following Examples, parts, % and ratio are parts by weight, % by weight and weight ratio, unless otherwise specified.

The procedures of the tests were performed in the following manner.

### Shower Water-Repellency Test (Spray)

Shower water-repellency test was conducted according to JIS-L-1092. The shower water-repellency was expressed by water-repellency No. (as shown in Table 1).

A glass funnel having a volume of at least 250 mL, and a spray nozzle which can spray 250 mL of water for 20-30 seconds are used. A test piece frame is a metal frame having a diameter of 15 cm. Three sheets of a test piece having a size of about 20 cm×20 cm are prepared and the sheet is mounted on a test piece holding frame so that the sheet has no wrinkle. The center of the spray is located on the center of the sheet. Room temperature water (250 mL) is charged into the glass funnel and sprayed on the test piece sheet (for time of 25-30 seconds). The holding frame is removed from a stand, one edge of the holding frame is grasped so that a front surface is downside and the other edge is lightly hit with a stiff substance. The holding frame is further rotated 180° and the same procedure is repeated to drop excess water droplets. The wet test piece is compared with a wet comparison standard to grade 0, 50, 70, 80, 90 and 100 points in order of poor water-repellency to excellent water-repellency. The results are obtained from an average of three measurements.

TABLE 1

| Water- | |
|---|---|
| repellency No. | State |
| 100 | No wet or water droplets adhesion on surface |
| 90 | No wet but small water droplets adhesion on surface |
| 80 | Separate small water droplets-like wet on surface |
| 70 | Wet on half of surface and separate small wet which |
| | penetrates fabric |
| 50 | Wet on whole surface |
| 0 | Wet on front and back whole surfaces |

### Oil-Repellency Test

A treated test fabric is stored in a thermo-hygrostat at a temperature of 21° C. and a humidity of 65% for at least 4 hours. A test liquid (shown in Table 2) is also stored at a temperature of 21° C. The test is conducted in a thermo-hygrostat chamber with a temperature of 21° C. and a humidity of 65%. 0.05 ml of the test liquid is dropped gently onto the test fabric. After left for 30 seconds, if the droplet remains on the test fabric, the test liquid is passed. Oil-repellency is the highest score of the passed test solution, which is evaluated in nine stages of Fail, 1, 2, 3, 4, 5, 6, 7, and 8 from poor to good water-repellency.

TABLE 2
Oil-repellency test liquid

| | | Surface tension |
|---|---|---|
| Score | Test liquid | (dyne/cm) |
| 8 | n-Heptane | 20.0 |
| 7 | n-Octane | 21.8 |
| 6 | n-Decane | 23.5 |
| 5 | n-Dodecane | 25.0 |
| 4 | n-Tetradecane | 26.7 |
| 3 | n-Hexadecane | 27.3 |
| 2 | n-Hexadecane35/Nujol 65 mixture liquid | 29.6 |
| 1 | Nujol | 31.2 |
| Fail | Inferior to 1 | — |

### Water-Repellency Test (IPA)

A treated test fabric is stored in a thermo-hygrostat at a temperature of 21° C. and a humidity of 65% for at least 4 hours. A test liquid (isopropyl alcohol (IPA), water and mixed liquid thereof, shown in Table 3) is also stored at a temperature of 21° C. The test is conducted in a thermo-hygrostat chamber with a temperature of 21° C. and a humidity of 65%. 50 μl of the test liquid is gently dropped onto the test fabric. After left for 30 seconds, if the droplet remains on the test fabric, the test liquid is passed. Water-repellency is the score of the passed test liquid of highest content (volume %) isopropyl alcohol (IPA), which is evaluated in 12 stages of Fail, 0, 1, 2, 3, 4, 5, 6, 7, 8, 9 and 10 from poor to good water-repellency.

TABLE 3
Water-repellency test liquid

(Volume ratio %)

| Score | Isopropyl alcohol | Water |
|---|---|---|
| 10 | 100 | 0 |
| 9 | 90 | 10 |
| 8 | 80 | 20 |
| 7 | 70 | 30 |
| 6 | 60 | 40 |
| 5 | 50 | 50 |
| 4 | 40 | 60 |
| 3 | 30 | 70 |
| 2 | 20 | 80 |
| 1 | 10 | 90 |
| 0 | 0 | 100 |

| | |
|---|---|
| Fail | Inferior to Isopropyl alcohol 0/water 100 |

### Water Pressure Test (Hydro Head)

According to AATCC 127-2003 water pressure resistance test method, water pressure resistance was measured with a water pressure resistance measuring apparatus.

### IPR (Water Impact Penetration Resistance) Test

The test was conducted according to AATCC TES Method 42-2000.

### Washing Durability

According to JIS L-0217-103, the water- and oil-repellency is evaluated by repeating washings 5, 10 and 20 times (HL5, 10, 20). HL0 means that the evaluation was done without washing.

### Production Example 1

65.1 g of CF₃CF₂—(CF₂CF₂)ₙ—CH₂CH₂OCOC(Cl)═CH₂ (n=2.0) (13FClA), 65.1 g of CF₃CF₂—(CF₂CF₂)ₙ—CH₂CH₂OCOCH═CH₂ (n=2.0) (13FA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Production Example 2

91.14 g of CF₃CF₂—(CF₂CF₂)ₙ—CH₂CH₂OCOC(Cl)═CH₂ (n=2.0) (13FClA), 39.06 g of CF₃CF₂—(CF₂CF₂)ₙ—CH₂CH₂OCOCH═CH₂ (n=2.0) (13FA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Production Example 3

39.53 g of CF₃CF₂—(CF₂CF₂)ₙ—CH₂CH₂OCOC(Cl)═CH₂ (n=2.0) (13FClA), 79.29 g of CF₃CF₂—(CF₂CF₂)—CH₂CH₂OCOCH═CH₂ (n=2.0) (13FA), 46.01 g of stearyl acrylate, 415 g of pure water, 60 g of a water-soluble glycol solvent and 20.5 g of polyoxyethylene alkyl ether were charged into a 1000 mL autoclave, and emulsified and dispersed with ultrasonic wave under stirring at 60° C. for 15 minutes. After replacing the inside of the flask with nitrogen, 50 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Production Example 4

65.1 g of CF₃CF₂—(CF₂CF₂)—CH₂CH₂OCOC(Cl)═CH₂ (n=2.0) (13FClA), 65.1 g of CF₃CF₂—(CF₂CF₂)ₙ—CH₂CH₂OCOC(CH₃)═CH₂ (n=2.0) (13FMA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Production Example 5

100 g of CF₃CF₂—(CF₂CF₂)ₙ—CH₂CH₂OCOC(Cl)═CH₂ (n=2.0) (13FClA), 33 g of CF₃CF₂—(CF₂CF₂)ₙ—CH₂CH₂OCOCH═CH₂ (n=2.0) (13FA), 89 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Comparative Production Example 1

108 g of CF₃CF₂—(CF₂CF₂)ₙ—CH₂CH₂OCOCH═CH₂ (n=3.2) (NSFA), 81.7 g of stearyl acrylate, 565 g of pure water, 47 g of a water-soluble glycol solvent and 30.3 g of polyoxyethylene alkyl ether were charged into a 1000 mL autoclave, and emulsified and dispersed by ultrasonic wave under stirring at 60° C. for 15 minutes. After replacing the inside of the flask with nitrogen, 62 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Comparative Production Example 2

130 g of CF₃CF₂—(CF₂CF₂)ₙ—CH₂CH₂OCOC(Cl)═CH₂ (n=2.0) (13FClA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Comparative Production Example 3

130 g of CF₃CF₂—(CF₂CF₂)ₙ—CH₂CH₂OCOCH═CH₂ (n=2.0) (13FA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Comparative Production Example 4

130 g of CF₃CF₂—(CF₂CF₂)ₙ—CH₂CH₂OCOC(CH₃)═CH₂ (n=2.0) (13FMA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Comparative Production Example 5

65 g of CF₃CF₂—(CF₂CF₂)ₙ—CH₂CH₂OCOCH═CH₂ (n=2.0) (13FA), 65 g of CF₃CF₂—(CF₂CF₂)ₙ—CH₂CH₂OCOC(CH₃)═CH₂ (n=2.0) (13FMA), 30.9 g of stearyl acrylate, 400 g of pure water, 56 g of a water-soluble glycol solvent, 1.56 g of alkyldimethylammonium chloride and 16.1 g of polyoxyethylene alkyl ether were charged into a 1000 mL autoclave, and emulsified and dispersed by ultrasonic wave under stirring at 60° C. for 15 minutes. After replacing the inside of the flask with nitrogen, 61.2 g of vinyl chloride (VCM) was press-injected in, 0.4 g of an azo group-containing water-soluble initiator was added, and the mixture was reacted at 60° C. for 20 hours to obtain an aqueous dispersion of polymer. A composition of the polymer was almost the same as a composition of the charged monomers.

### Example 1

The aqueous liquid prepared in Production Example 1 was diluted with pure water so that the concentration of the fluorine-containing polymer became 30% solid content, further diluted with water so that the proportion of the 30% diluted liquid was 5%, a test liquid (100 g) of 5.00% was prepared. An aqueous dispersion of methyl ketoxime block methylene diisocyanate (BI) as a crosslinking agent was added at 1.00% and stirred sufficiently, then 10 sheets of polyethylene terephthalate (PET) woven fabric (500 mm×200 mm) and Nylon woven fabric (500 mm×200 mm) were continuously immersed in this test liquid, passed through a mangle and treated with a pin tenter at 170° C. for 1 minute. Likewise, after diluting the concentration of the fluorine-containing polymer to be a 30% solid content, further diluting with water so that a proportion of the 30% diluted liquid was 1%, and PP (Poly Propylene) nonwoven fabric (500 mm×200 mm) was immersed, passed through a mangle and treated with a pin tenter at 135° C. for 30 seconds. Thereafter, each of the PET woven fabric and the Nylon woven fabric was subjected to the shower water-repellency test, the oil-repellency test and the washing durability test thereof, and the PP nonwoven fabric was subjected to the water-repellency test (the shower water-repellency test, the water-repellency test (IPA), the IPR test, the water pressure resistance test). The results are shown in Table A.

### Example 2

The aqueous liquid prepared in Production Example 2 was diluted with pure water so that the concentration of the fluorine-containing polymer was 30% solid content. Thereafter, the same procedure as in Example 1 was carried out and evaluated. The results are shown in Table A.

### Example 3

The aqueous liquid prepared in Production Example 3 was diluted with pure water so that the concentration of the fluorine-containing polymer was 30% solid content. Thereafter, the same procedure as in Example 1 was carried out and evaluated. The results are shown in Table A.

### Example 4

The aqueous liquid prepared in Production Example 4 was diluted with pure water so that the concentration of the fluorine-containing polymer was 30% solid content. Thereafter, the same procedure as in Example 1 was carried out and evaluated. The results are shown in Table A.

### Example 5

The aqueous liquid prepared in Production Example 5 was diluted with pure water so that the concentration of the fluorine-containing polymer was 30% solid content. Thereafter, the same procedure as in Example 1 was carried out and evaluated. The results are shown in Table A.

### Comparative Example 1

The aqueous liquid prepared in Comparative Production Example 1 was diluted with pure water so that the concentration of the fluorine-containing polymer was 30% solid content. Thereafter, the same procedure as in Example 1 was carried out and evaluated. The results are shown in Table A.

### Comparative Example 2

The aqueous liquid prepared in Comparative Production Example 2 was diluted with pure water so that the concentration of the fluorine-containing polymer was 30% solid content. Thereafter, the same procedure as in Example 1 was carried out and evaluated. The results are shown in Table A.

### Comparative Example 3

The aqueous liquid prepared in Comparative Production Example 3 was diluted with pure water so that the concentration of the fluorine-containing polymer was 30% solid content. Thereafter, the same procedure as in Example 1 was carried out and evaluated. The results are shown in Table A.

### Comparative Example 4

The aqueous liquid prepared in Comparative Production Example 4 was diluted with pure water so that the concentration of the fluorine-containing polymer was 30% solid content. Thereafter, the same procedure as in Example 1 was carried out and evaluated. The results are shown in Table A.

### Comparative Example 5

The aqueous liquid prepared in Comparative Production Example 5 was diluted with pure water so that the concentration of the fluorine-containing polymer was 30% solid content. Thereafter, the same procedure as in Example 1 was carried out and evaluated. The results are shown in Table A.

The meanings of symbols are as follows.

TABLE 4

| Symbol | Compound name•Chemical formula |
|---|---|
| 13FClA | C₆F₁₃CH₂CH₂OCOC(Cl)═CH₂ |
| 13FA | C₆F₁₃CH₂CH₂OCOCH═CH₂ |
| 13FMA | C₆F₁₃CH₂CH₂OCOC(CH₃)═CH₂ |
| StA | C₁₈H₃₇OCOCH═CH₂ |
| VCM | CH₂═CHCl |
| NSFA | C₈F₁₇CH₂CH₂OCOC(CH₃)═CH₂ |
| BI | Methyl ketoxime block methylene diisocyanate aqueous |
| | dispersion |

TABLE A

| | | | Example | | | | | Comparative Example | | | | |
|---|---|---|---|---|---|---|---|---|---|---|---|---|
| | | | 1 | 2 | 3 | 4 | 5 | 1 | 2 | 3 | 4 | 5 |
| | | | Monomer | | | | | | | | | |
| | | | | | | | | Com. | Com. | Com. | Com. | Com. |
| | | | Prod. | Prod. | Prod. | Prod. | Prod. | Prod. | Prod. | Prod. | Prod. | Prod. |
| | | | Ex. 1 | Ex. 2 | Ex. 3 | Ex. 4 | Ex. 5 | Ex. 1 | Ex. 2 | Ex. 3 | Ex. 4 | Ex. 5 |
| | 13FCLA | | 29.3 | 41 | 18.4 | 29.3 | 45 | | 58.6 | | | |
| | 13FA | | 29.3 | 17.6 | 36.9 | | 15 | | | 58.6 | | 29.3 |
| | 13FMA | | | | | 29.3 | | | | | 58.6 | 29.3 |
| | NSFA | | | | | | | 43 | | | | |
| | StA | | 14 | 14 | 21.4 | 14 | 40 | 32.4 | 14 | 14 | 14 | 14 |
| | VCM | | 27.4 | 27.4 | 23.3 | 27.4 | | 24.6 | 27.4 | 27.4 | 27.4 | 27.4 |
| | Total | | 100 | 100 | 100 | 100 | 100 | 100 | 100 | 100 | 100 | 100 |
| Used | Used | Repellency | 5% | 5% | 5% | 5% | 5% | 5% | 5% | 5% | 5% | 5% |
| fabric | Concentration | BI | 1% | 1% | 1% | 1% | 1% | 1% | 1% | 1% | 1% | 1% |
| PET | Spray | HL0 | 100 | 100 | 100 | 100 | 100 | 100 | 100 | 80 | 100 | 80 |
| Woven | | HL5 | 100 | 100 | 100 | 100 | 90 | 100 | 90 | 70 | 70 | 70 |
| fabric | | HL10 | 90 | 90 | 90 | 90 | 80 | 90 | 70 | 50 | 50 | 50 |
| cured at | | HL20 | 80 | 85 | 80 | 70 | 70 | 70 | 50 | 50 | 50 | 50 |
| 170° C. | Oil- | HL0 | 5 | 5 | 5 | 5 | 5 | 5 | 4 | 5 | 4 | 4 |
| for 1 min. | repellency | HL5 | 5 | 4 | 5 | 4 | 4 | 4 | 3 | 5 | 3 | 4 |
| | | HL10 | 4 | 4 | 4 | 4 | 4 | 4 | 2 | 3 | 2 | 2 |
| | | HL20 | 4 | 4 | 4 | 4 | 4 | 3 | 2 | 2 | 1 | 1 |
| Nylon | Spray | HL0 | 100 | 100 | 100 | 100 | 100 | 100 | 100 | 80 | 100 | 90 |
| Woven | | HL5 | 90 | 95 | 90 | 90 | 80 | 90 | 85 | 70 | 70 | 70 |
| fabric | | HL10 | 85 | 90 | 80 | 80 | 70 | 80 | 70 | 50 | 50 | 50 |
| cured at | | HL20 | 80 | 85 | 70 | 80 | 60 | 70 | 50 | 50 | 50 | 50 |
| 170° C. | Oil- | HL0 | 5 | 5 | 5 | 5 | 5 | 5 | 3 | 5 | 4 | 4 |
| for 1 min. | repellency | HL5 | 5 | 4 | 5 | 4 | 4 | 4 | 3 | 4 | 3 | 3 |
| | | HL10 | 4 | 4 | 4 | 4 | 3 | 3 | 2 | 3 | 2 | 2 |
| | | HL20 | 4 | 4 | 4 | 4 | 2 | 3 | 2 | 2 | 1 | 1 |
| PP Non-woven | Spray | | 90 | 90 | 90 | 80 | 90 | 70 | 60 | 50 | 70 | 70 |
| fabric | IPA | | 8 | 8 | 9 | 8 | 9 | 5 | 4 | 4 | 4 | 5 |
| cured at | IPR(g) | | 0.11 | 0.12 | 0.11 | 0.15 | 0.1 | 0.24 | 0.23 | 0.25 | 025 | 028 |
| 135° C. × | HH(mmbr) | | 67.3 | 624 | 64.2 | 621 | 65.2 | 42.1 | 45.3 | 48.2 | 50.2 | 43.2 |
| 30 sec. | | | | | | | | | | | | |

### INDUSTRIAL APPLICABILITY

The surface-treating composition of the present invention may be used, for example, as a water- and oil-repellent agent, a soil resistant agent and a soil release agent.

What is claimed is:

1. A surface-treating composition comprising
(1) a fluorine-containing polymer having a repeating unit derived from (a) a fluorine-containing monomer comprising (a1) a first fluorine-containing monomer and (a2) a second fluorine-containing monomer,
wherein the first fluorine-containing monomer (a1) is a compound represented by the formula:
CH₂═C(—X¹)—C(═O)—Y¹—Z¹—Rf¹
wherein
X¹ is a halogen atom,
Y¹ is —O— or —NH—,
Z¹ is a direct bond or a divalent organic group, and
Rf¹ is a fluoroalkyl group having 1 to 6 carbon atoms, and
the second fluorine-containing monomer (a2) is a compound represented by the formula:
CH₂═C(—X²)—C(═O)—Y²—Z²—Rf²
wherein
X² is a monovalent organic group or a hydrogen atom,
Y² is —O— or —NH—,
Z² is a direct bond or a divalent organic group, and
Rf² is a fluoroalkyl group having 1 to 6 carbon atoms and
(2) liquid medium which is an aqueous medium.

2. The surface-treating composition according to claim 1,
wherein
X¹ is a chlorine atom in the first fluorine-containing monomer (a1),
X² is a hydrogen atom in the second fluorine-containing monomer (a2), and
the weight ratio (a1):(a2) of the first fluorine-containing monomer (a1) to the second fluorine-containing monomer (a2) is from 5:95 to 95:5.

3. The surface-treating composition according to claim 1,
wherein
in the first fluorine-containing monomer (a1) and the second fluorine-containing monomer (a2),
each of Y¹ and Y² is —O—,
each of Z¹ and Z² is, the same as or different from each other, and is a direct bond, an aliphatic group having 1 to 10 carbon atoms, an aromatic group or a cycloaliphatic group having 6 to 18 carbon atoms, a group represented by the formula —R²(R¹)N—SO₂— or —R²(R¹)N—CO— (wherein R¹ is an alkyl group having 1 to 10 carbon atoms, and R² is a linear alkylene group or a branched alkylene group having 1 to 10 carbon atoms), a group represented by the formula —CH₂CH(OR³)CH₂—(Ar—O)ₚ— (wherein R³ is a hydrogen atom or an acyl group having 1 to 10 carbon atoms, Ar is an arylene group, and p is 0 or 1), a group represented by the formula —(CH₂)ᵣ—Ar—(O)_{q}— (wherein Ar is an arylene group, q is 0 or 1, and r is 0 to 10), or a group represented by the formula —(CH₂)ₘ—SO₂—(CH₂)ₙ— or —(CH₂)ₘ—S—(CH₂)ₙ— (wherein m is 1 to 10, and n is 0 to 10).

4. The surface-treating composition according to claim 1,
wherein
the fluorine-containing polymer further has a repeating unit derived from:
(b) a fluorine-free monomer,
wherein the fluorine-free monomer (b) comprises:
(b1) a fluorine-free non-crosslinkable monomer
represented by the formula:
CH₂=CA-T
wherein
A is a hydrogen atom, a methyl group or a halogen atom other than a fluorine atom,
T is a hydrogen atom, a halogen atom other than a fluorine atom, a chain or cyclic hydrocarbon group having 1 to 30 carbon atoms, or a chain or cyclic organic group having 1 to 30 carbon atoms and having an ester bond.

5. The surface-treating composition according to claim 4,
wherein
the fluorine-free non-crosslinkable monomer (b1) is at least one of:
(b1-1) an acrylate ester monomer represented by the formula:
CH₂=CA²¹-C(═O)—O-A²²
wherein
A²¹ is a hydrogen atom, a monovalent organic group or a halogen atom other than a fluorine atom, and
A²² is a hydrocarbon group having 1 to 30 carbon atoms, and
(b1-2) a halogenated olefin monomer which is an olefin having 2 to 20 carbon atoms substituted with 1 to 10 chlorine, bromine or iodine atoms.

6. The surface-treating composition The fluorine-containing polymer according to claim 5,
wherein A²² is an acyclic aliphatic hydrocarbon group having 12 to 30 carbon atoms in the acrylate ester monomer (b1-1).

7. The surface-treating composition according to claim 5,
wherein the halogenated olefin monomer (b1-2) is vinyl chloride or vinylidene chloride.

8. The surface-treating composition according to claim 1,
wherein the amount of the fluorine-containing monomer (a) is 20 to 90% by weight, and the amount of a fluorine-free monomer (b) is 10 to 80% by weight, based on the total amount of the fluorine-containing monomer (a) and the fluorine-free monomer (b).

9. The surface-treating composition according to claim 1 comprising:
(3) surfactant.

10. The surface-treating composition comprising according to claim 1, which further comprises (4) a curing agent, wherein the curing agent is a blocked polyisocyanate compound.

11. The surface-treating composition comprising according to claim 9, wherein the amount of the fluorine-containing polymer (1) is from 0.01 to 60% by weight based on the surface-treating composition, the amount of the liquid medium (2) is from 30 to 99.5% by weight based on the surface-treating composition, and the amount of the surfactant (3) is from 0.1 to 50 parts by weight, based on 100 parts by weight of the fluorine-containing polymer.

12. A method for producing a treated textile product, comprising a step of applying the surface-treating composition according to claim 1, to a textile product.

13. The producing method according to claim 12,
wherein the textile product is a nonwoven fabric, and the weight ratio (a1):(a2) of the repeating unit (a1) to the repeating unit (a2) in the fluorine-containing polymer is 20:80 to 45:55.

14. The producing method according to claim 12,
wherein the textile product is a knitted/woven fabric, and the weight ratio (a1):(a2) of the repeating unit (a1) to the repeating unit (a2) in the fluorine-containing polymer is 50:50 to 75:25.

15. A treated textile product obtained by treating with the surface-treating composition according to claim 1.

16. The surface-treating composition comprising according to claim 1,
wherein Rf¹ and Rf² are a perfluoroalkyl group.

17. The surface-treating composition comprising according to claim 1,
wherein the amount of the repeating unit derived from the fluorine-containing monomer (a) in the fluorine-containing polymer is at least 40% by weight.

18. The surface-treating composition comprising according to claim 1,
wherein the amount of an organic solvent is at most 30% by weight in the liquid medium.
